(19) United States
(12) Patent Application Publication
(10) Pub. No.: US 2006/0026786 A1
(43) Pub. Date: Feb. 9, 2006

(54) Windshield wiper

(76) Inventor: Shu-Lan Ku, (US)

Correspondence Address: BIRCH STEWART KOLASCH & BIRCH, PO BOX 747, FALLS CHURCH, VA, 22040-0747, US

(21) Appl. No.: 10/910,309

(22) Filed: Aug. 4, 2004

(51) Int. Cl. B60S 1/40; B60S 1/38

(52) U.S. Cl. 15/250.32; 15/250.43; 15/250.202

(57) ABSTRACT

A windshield wiper installed, stick closely on the front, rear windshield to wipe out water and comprising an elastic slice, a buckle, a rubber cover and a wiper blade; the elastic slice is a metal slice in curve shape and is in one piece design, two rubber covers in “A” shape are inserted from right and left sides of the metal slice to have the rubber covers on top of the metal slice to increase the elasticity and tenacity of the metal slice, such design is strong and also lowers the manufacturing cost, the fastening indentation on center of the metal slice can allow wiper blade slide in for convenient installation and replacement, the wiper blade can be replaced along without replacing the whole set to reduce the waste.

### BACKGROUND OF THE INVENTION

I. Field of the Invention

This invention relates generally to a windshield wiper and, more specifically, to a windshield wiper that comprises an elastic slice, a buckle, a rubber cover and a wiper blade, the structure is strong, durable, the manufacturing cost is low, the installation and replacement is simple, the wiper blade is replaceable to reduce waste, such saves cost for users.

II. Description of the Prior Art

Heretofore, it is known that windshield wipers a of general automobiles, as shown in FIG. 1, comprises of several arms a1 made of metal combined together, and a rubber wiper blade b wedged on the bottom arm a1, a buckle a2 on the center of the topmost arm a1; while application, the buckle a2 is fastened onto the arm of the wiper motor, by the driving of the wiper motor, the windshield wiper a moves back and forth on the windshield to wipe the water on the windshield. Such structure needs many components, the assembly is not very convenient; for deterioration, after certain period of time, the rubber wiper blade b cannot wipe the water completely on the windshield that will influence the driving safety, the windshield wiper blade b needed to be replaced; however the replacement is very difficult, most users replace the whole set that wastes money, the replaced wipers also causes material waste.

### SUMMARY OF THE INVENTION

It is therefore a primary object of the invention to provide a windshield wiper that is strong and durable, very convenient to install and replace, and reduce waste of material and cost.

In order to achieve the objective set forth, a windshield wiper in accordance with the present invention comprises an elastic slice, a buckle, a rubber cover and a wiper blade. The elastic slice is a metal slice in curve shape with a fastening indentation on the center; the fastening indentation is in long strip shape. The buckle is made of metal with a hookup part on top to hook the buckle and the wiper motor together. The cross section of the rubber cover is in “A” shape, a concave depression with the size corresponding to that of the elastic slice is on the bottom of the rubber cover, a pair of rubber side covers made of the same rubber with the shape corresponding to and larger than the rubber cover are on both end of the rubber cover to wrap both sides of the elastic slice.

While assembly, the buckle is fastened onto the center of the elastic slice directly, then the rubber cover and the side covers are inserted and fastened to the elastic slice, finally the wiper blade is slid into and clipped on the fastening indentation, the buckle clips the whole set on the wiper motor. The installation is very convenient, the elastic slice and the rubber cover increase the thickness that increases the elasticity and tenacity, the cost of components and assembly cost is lower; the wiper blade of the present invention is replaceable to reduce waste, such saves cost for users.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the prior art;

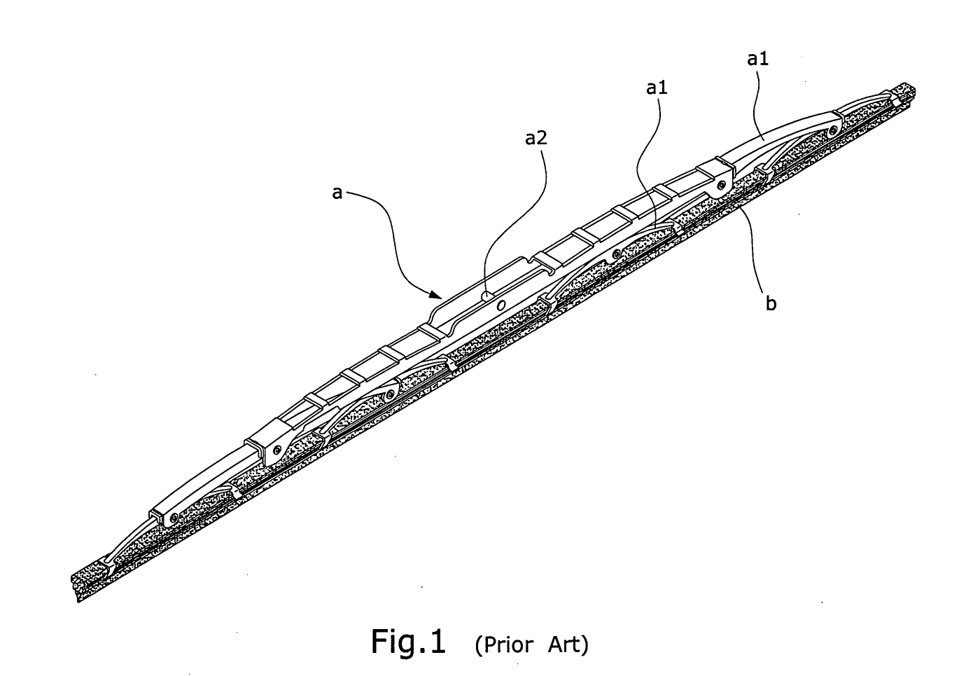

FIG. 2 is an assembly view of the present invention;

FIG. 3 is a perspective view of the present invention;

FIG. 4A is a cross-sectional view of the present invention;

FIG. 4B is another cross-sectional view of present invention.

### DESCRIPTION OF THE PREFERRED EMBODIMENT

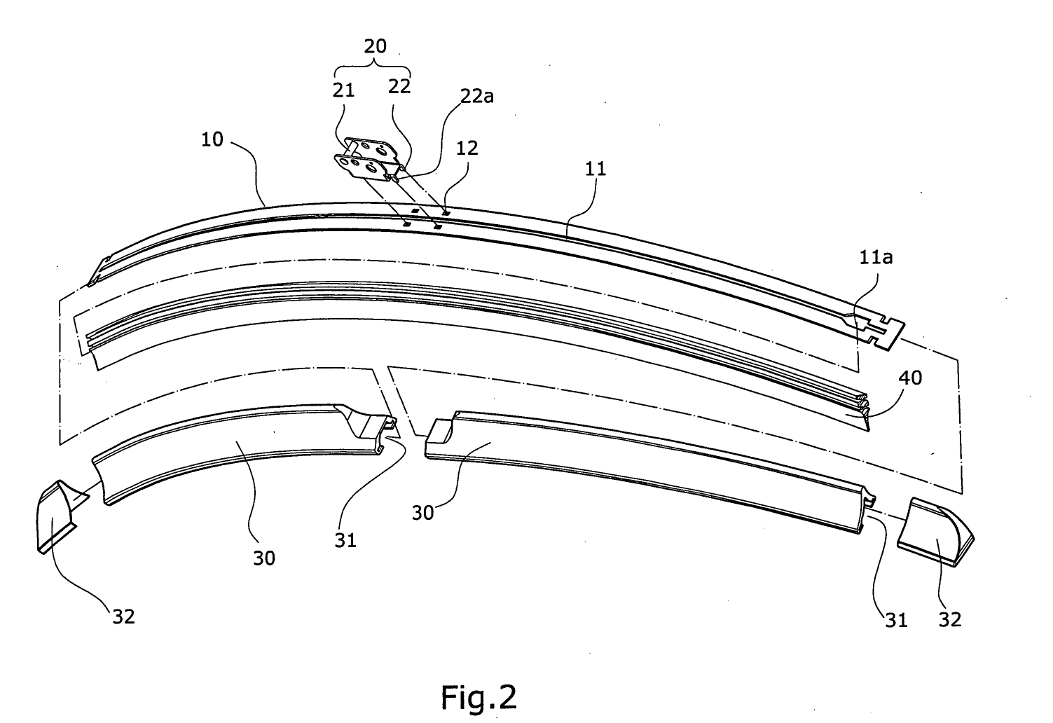

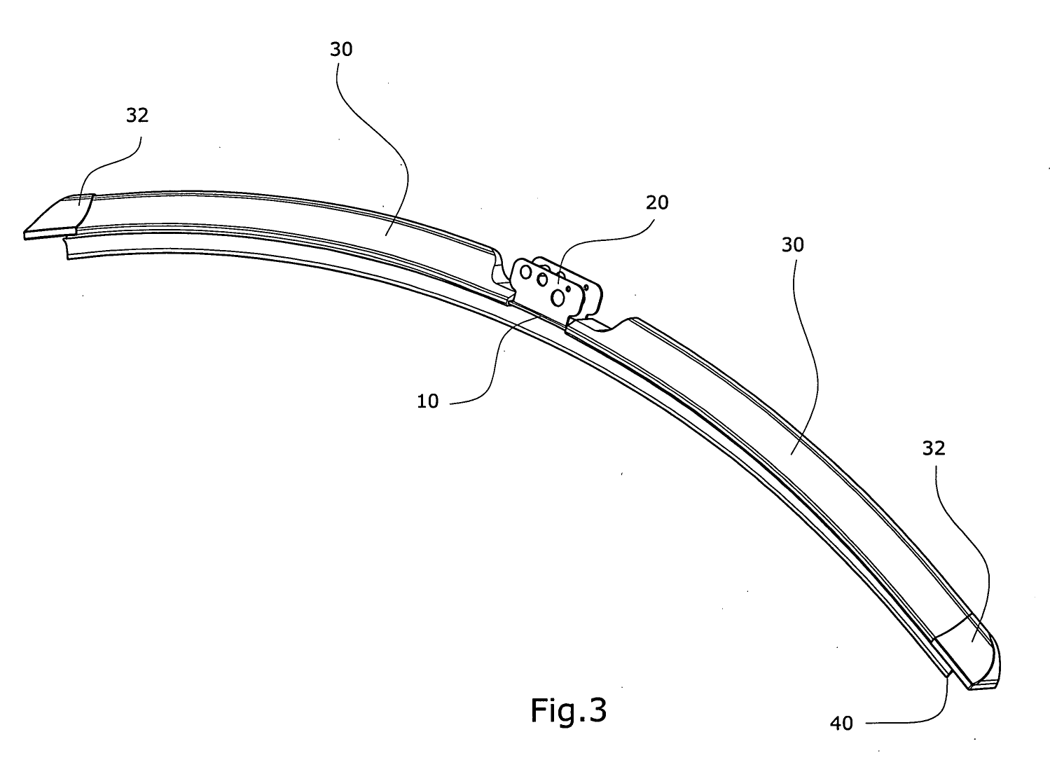

Referring to FIG. 2 and FIG. 3, the present invention comprises an elastic slice 10, a buckle 20, a rubber cover 30 and a wiper blade 40. The function of each component is described as following:

The elastic slice 10 is a metal slice in curve shape with a fastening indentation 11 on the center, the fastening indentation 11 is in long strip shape; an open hole 11a is on one end of the fastening indentation 11 to install wiper blade 40, four fastening holes 12 are on the middle of the elastic slice 10.

The buckle 20 is made of metal with a hookup part 21 on top to hook the buckle 20 and the wiper motor together, a fastening part 22 is on the bottom of the buckle 20 to fasten the elastic slice 10, four small claws 22a fasten the buckle 20 onto the fastening holes 12 of the elastic slice 10.

The rubber cover 30 is injected and formed into one body, the cross section of the rubber cover 30 is in “A” shape, a concave depression 31 with the size corresponding to that of the elastic slice 10 is on the bottom of the rubber cover 30, a pair of rubber side covers 32 made of the same rubber with the shape corresponding to and larger than the rubber cover 30 are on both end of the rubber cover 30 to wrap both sides of the elastic slice 10.

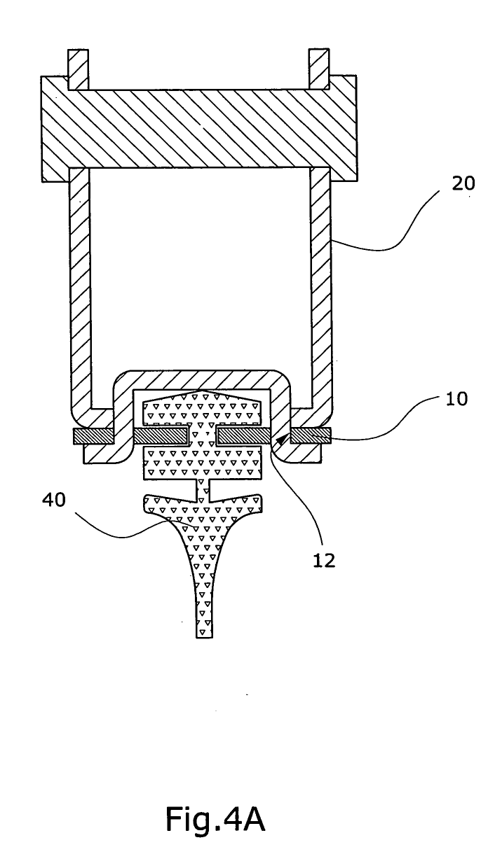

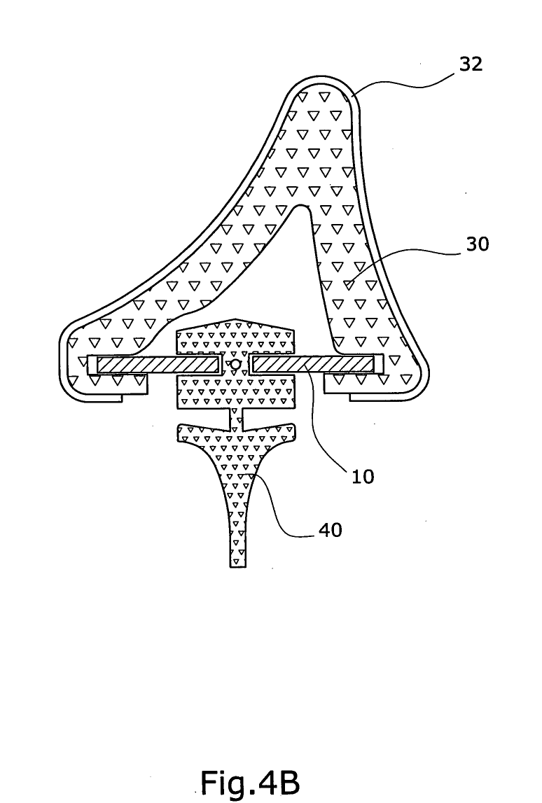

While assembly and referring to FIG. 4A and FIG. 4B, the buckle 20 is fastened onto the fastening holes 12 of the elastic slice 10 directly, then the rubber cover 30 and the side covers 32 are inserted and fastened to the elastic slice 10, finally the wiper blade 40 is slid into and clipped on the fastening indentation 11, the buckle 20 clips the whole set on the wiper motor.

While a preferred embodiment of the invention has been shown and described in detail, it will be readily understood and appreciated that numerous omissions, changes and additions may be made without departing from the spirit and scope of the invention.

1-5. (canceled)

6. A windshield wiper comprising an elastic slice, a buckle, a rubber cover and a wiper blade, the buckle being attached by fastening holes to the elastic slice, the elastic slice being a one-piece element having a centrally disposed, longitudinal opening therein, the rubber cover and a pair of side covers being inserted onto the elastic slice, the wiper blade being insertable into the longitudinal opening of the elastic slice with the elastic slice surrounding the wiper blade, the buckle being connectable to an arm of a wiper motor.

7. The windshield wiper recited in claim 6, wherein the elastic slice is curved with the longitudinal opening being centrally located and having an enlarged hole at one end to receive the wiper blade during installation.

8. The windshield wiper recited in claim 7, wherein the fastening holes for the buckle include four holes in the middle of the elastic slice.

9. The windshield wiper recited in claim 8, wherein two fastening holes are on each side of the longitudinal opening of the elastic slice.

10. The windshield wiper recited in claim 6, wherein the buckle is made of metal with a hookup part on a top to hook the buckle and the arm together, a fastening part being provided on a bottom of the buckle to fasten the buckle to the elastic slice, a plurality of claws being provided on the fastening part on the bottom of the buckle to be inserted into the fastening holes.

11. The windshield wiper recited in claim 6, wherein the rubber cover is injected and formed into one body, a cross section of the rubber cover having an “A” shape, a concave depression being provided to receive the elastic slice on the bottom of the rubber cover.

12. The windshield wiper recited in claim 11, wherein a pair of rubber side covers made of a same rubber as the rubber cover is provided, the rubber side covers being at ends of the rubber cover and having a shape corresponding to the rubber cover, the rubber side covers wrap ends of the elastic slice.

13. The windshield wiper recited in claim 6, wherein the rubber cover includes two, separate sections, the buckle being located between the two sections.

14. The windshield wiper recited in claim 13, wherein the buckle directly connects with the elastic slice.
